(19) United States
(12) Patent Application Publication
(10) Pub. No.: US 2025/0211391 A1
(43) Pub. Date: Jun. 26, 2025

(54) SUPPORT OF SRS TRANSMISSION WITH 8 ANTENNA PORTS

(71) Applicant: LENOVO (BEIJING) LIMITED, Beijing (CN)

(72) Inventors: Bingchao Liu, Beijing (CN); Chenxi Zhu, Fairfax, VA (US); Lingling Xiao, Beijing (CN); Wei Ling, Beijing (CN); Yi Zhang, Beijing (CN)

(21) Appl. No.: 18/849,017

(22) PCT Filed: Aug. 3, 2022
(86) PCT No.: PCT/CN2022/109942

§ 371 Date: Sep. 20, 2024

(51) Int. Cl. H04L 5/00; H04W 72/1268

(52) U.S. Cl. CPC H04L 5/0051; H04L 5/0044; H04L 5/0092; H04W 72/1268

(57) ABSTRACT

Methods and apparatuses for SRS enhancement are disclosed. In one embodiment, a UE comprises a transceiver; and a processor coupled to the transceiver, wherein the processor is configured to receive, via the transceiver, a configuration of a group of SRS resource(s) associated with a same UL TCI state with a total of eight SRS ports for sounding eight antenna ports used for codebook or non-codebook based PUSCH transmission; and receive, via the transceiver, a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

### FIELD

The subject matter disclosed herein generally relates to wireless communications, and more particularly relates to methods and apparatuses for SRS enhancement.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), codebook (CB), non-codebook (nCB), Bandwidth part (BWP), non-zero power (NZP), Channel State Information Reference Signal (CSI-RS), Transmission Configuration Indicator (TCI), Downlink Control Information (DCI), Most Significant Bit (MSB), Least Significant Bit (LSB), Sounding Reference Signal (SRS), SRS resource indicator (SRI), SRS resource set indicator (SRSI), Physical Uplink Shared Channel (PUSCH), cyclic shift (CS), Customer Premise Equipment (CPE), Fixed Wireless Access (FWA), transmission-reception point (TRP), media access control (MAC), control element (CE), frequency hopping (FH), configured-grant (CG), Time Domain Orthogonal Cover Code (TD-OCC).

SRS is used for UL channel estimation for UL scheduling. The gNB can also obtain the DL channel or some parameters of the DL channel by SRS based on channel reciprocity. In NR Release 17, up to 4 antenna ports (4Tx) can be used for UL transmission for typical UE devices. As a result, PUSCH transmission with only up to 4 layers can be scheduled on 4 PUSCH or SRS antenna ports.

In NR Release 17, for 4Tx UE, one SRS resource set can be configured for a UE in a BWP of a cell for single TRP scenario, where up to two SRS resources each with 4 SRS ports can be configured in the one SRS resource set. Different SRS resources in the set are transmitted on different OFDM symbols with different UL TX spatial filters. Different SRS ports of a SRS resource are assigned with orthogonal resources by configuring different frequency resources and/or different orthogonal SRS sequences. In the following description, “OFDM symbol” is abbreviated as “symbol”.

In frequency domain, SRS has a comb structure, implying that an SRS is transmitted on every K^{th} subcarrier of the sounding bandwidth, where K can be 2, 4 or 8 corresponding to comb-2, comb-4 or comb-8, which can be represented by K_{TC}=2 or 4 or 8. Different SRS ports of a same SRS resource can be frequency multiplexed by being assigned with different comb offsets. For example, when comb-2 (K_{TC}=2) is configured for a SRS resource with two SRS ports, all the odd subcarriers are assigned to one SRS port and all the even subcarriers are assigned to the other SRS port.

In sequence domain, orthogonal sequences can be assigned to different SRS ports of a SRS resource by assigning different cyclic shifts (CSs) of a same SRS sequence. Since different CSs of a SRS sequence is equivalent to a phase rotation in frequency domain, the number of available CSs named the maximum number of CSs corresponding to different comb sizes is limited as in Table 1, which is Table 6.4.1.4.2-1 specified in TS38.211 V17.2.0.

TABLE 1
Maximum number of cyclic shifts (n_{SRS}^{cs, max}) as a function of K_{TC}

| K_{TC} | n_{SRS}^{cs, max} |
|---|---|
| 2 | 8 |
| 4 | 12 |
| 8 | 6 |

As advanced UEs (e.g. CPE, FWA, vehicle, industrial devices) become more relevant, the support for 8 antenna ports (as well as more than 4 layers for UL transmission) can offer necessary improvement for UL coverage and average throughput. To support 8 antenna ports (8Tx) UL transmission, SRS should be enhanced as well.

This disclosure targets SRS enhancement to support 8 ports SRS.

### BRIEF SUMMARY

Methods and apparatuses for SRS enhancement are disclosed.

In one embodiment, a UE comprises a transceiver; and a processor coupled to the transceiver, wherein the processor is configured to receive, via the transceiver, a configuration of a group of SRS resource(s) associated with a same UL TCI state with a total of eight SRS ports for sounding eight antenna ports used for codebook or non-codebook based PUSCH transmission; and receive, via the transceiver, a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

In some embodiment, the group of SRS resource(s) is one SRS resource with eight SRS ports. The eight SRS ports of the one SRS resource may be transmitted in one symbol with different comb offsets and two or more different CS values. Alternatively, the eight SRS ports of the one SRS resource may be transmitted in two adjacent symbols. In this condition, each pair of SRS ports of the one SRS resource are multiplexed by TD-OCC [1 1] and [1 −1], and share the same comb offset and the same CS value. In addition, if one of the two symbols is dropped due to collision handling, the one SRS resource on the two symbols is dropped.

In some embodiment, the group of SRS resource(s) is two SRS resources each with four SRS ports, the four SRS ports of each SRS resource are associated with four antenna ports belonging to a different coherent antenna group. The SRS resource indicator field indicates an index corresponding to 2 SRI values, where each SRI value indicates one SRS resource, or the SRS resource indicator field indicates an SRI value that corresponds to 2 SRS resources.

In some embodiment, the group of SRS resource(s) is four SRS resources each with two SRS ports, the two SRS ports of each SRS resource are associated with two antenna ports belonging to a different coherent antenna group. The SRS resource indicator field indicates an index corresponding to 4 SRI values, where each SRI value indicates one SRS resource; or the SRS resource indicator field indicates an SRI value that corresponds to 4 SRS resources.

In the condition that the group of SRS resource(s) is two or four SRS resources each of which is transmitted in a different symbol, if at least one of the symbols for transmitting any of the SRS resources is dropped due to collision handling, the group of SRS resource(s) are dropped.

In some embodiment, the same frequency hopping parameters and/or the same repetition factors are configured for the SRS resources within an SRS group, and frequency hopping and/or frequency repetition are performed per SRS group of SRS resource(s).

In some embodiment, the group of SRS resource(s) is two SRS resource sets with a total of eight SRS resources each with one SRS port for non-codebook. If the two SRS resource sets are configured as aperiodic, the two aperiodic SRS resource sets are triggered by a same SRS request codepoint; and if the two SRS resource sets are configured as semi-persistent, the two semi-persistent SRS resource sets are activated or deactivated by a same MAC CE. The eight SRS resources within the two SRS resource sets may be associated with an aperiodic NZP CSI-RS resource, and a 42-symbols gap between the last symbol of the reception of the aperiodic NZP CSI-RS resource and the first symbol of the aperiodic SRS transmission in a first of the two SRS resource sets is satisfied.

In another embodiment, a method performed at a UE comprises receiving a configuration of a group of SRS resource(s) associated with a same UL TCI state with a total of eight SRS ports for sounding eight antenna ports used for codebook or non-codebook based PUSCH transmission; and receiving a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

In still another embodiment, a base unit comprises a transceiver; and a processor coupled to the transceiver, wherein the processor is configured to transmit, via the transceiver, a configuration of a group of SRS resource(s) associated with a same UL TCI state with a total of eight SRS ports for sounding eight antenna ports used for codebook or non-codebook based PUSCH transmission; and transmit, via the transceiver, a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

In some embodiment, the group of SRS resource(s) is one SRS resource with eight SRS ports. The eight SRS ports of the one SRS resource may be received in one symbol with different comb offsets and two or more different CS values. Alternatively, the eight SRS ports of the one SRS resource may be received in two adjacent symbols. In this condition, each pair of SRS ports of the one SRS resource are multiplexed by TD-OCC [1 1] and [1 −1], and share the same comb offset and the same CS value. In addition, if one of the two symbols is dropped due to collision handling, the one SRS resource on the two symbols is dropped.

In some embodiment, the group of SRS resource(s) is two SRS resources each with four SRS ports, the four SRS ports of each SRS resource are associated with four antenna ports belonging to a different coherent antenna group. The SRS resource indicator field indicates an index corresponding to 2 SRI values, where each SRI value indicates one SRS resource, or the SRS resource indicator field indicates an SRI value that corresponds to 2 SRS resources.

In some embodiment, the group of SRS resource(s) is four SRS resources each with two SRS ports, the two SRS ports of each SRS resource are associated with two antenna ports belonging to a different coherent antenna group. The SRS resource indicator field indicates an index corresponding to 4 SRI values, where each SRI value indicates one SRS resource; or the SRS resource indicator field indicates an SRI value that corresponds to 4 SRS resources.

In the condition that the group of SRS resource(s) is two or four SRS resources each of which is received in a different symbol, if at least one of the symbols for receiving any of the SRS resources is dropped due to collision handling, the group of SRS resource(s) are dropped.

In some embodiment, the same frequency hopping parameters and/or the same repetition factors are configured for the SRS resources within an SRS group, and frequency hopping and/or frequency repetition are performed per SRS group of SRS resource(s).

In some embodiment, the group of SRS resource(s) is two SRS resource sets with a total of eight SRS resources each with one SRS port for non-codebook. If the two SRS resource sets are configured as aperiodic, the two aperiodic SRS resource sets are triggered by a same SRS request codepoint; and if the two SRS resource sets are configured as semi-persistent, the two semi-persistent SRS resource sets are activated or deactivated by a same MAC CE. The eight SRS resources within the two SRS resource sets may be associated with an aperiodic NZP CSI-RS resource, and a 42-symbols gap between the last symbol of the reception of the aperiodic NZP CSI-RS resource and the first symbol of the aperiodic SRS transmission in a first of the two SRS resource sets is satisfied.

In yet another embodiment, a method performed at a base unit comprises transmitting a configuration of a group of SRS resource(s) associated with a same UL TCI state with a total of eight SRS ports for sounding eight antenna ports used for codebook or non-codebook based PUSCH transmission; and transmitting a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1(a) illustrates fully coherent antenna layout;

FIG. 1(b) illustrates non-coherent antenna layout;

FIG. 1(c) illustrates partial-coherent antenna layout 1;

FIG. 1(d) illustrates partial-coherent antenna layout 2;

FIG. 2 illustrates a configuration of an SRS resource set for 8 Tx UE with 4 SRS resources each with 4 SRS ports;

FIG. 3 illustrates a configuration of an SRS resource set for 8 Tx UE with 8 SRS resources each with 2 SRS ports;

FIG. 4 illustrates a configuration of two SRS resource sets for 8 Tx UE each with 4 SRS resources each with 2 SRS ports;

FIG. 5(a) illustrates an example for frequency hopping;

FIG. 5(b) illustrates an example for frequency repetition;

FIG. 6 illustrates an example of the bitmap based SRI indication;

FIG. 7 is a schematic flow chart diagram illustrating an embodiment of a method;

FIG. 8 is a schematic flow chart diagram illustrating an embodiment of another method; and

FIG. 9 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), crasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”. “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

First, an introduction on the antenna layout is provided.

Different antenna groups can be configured for different antenna layouts. For discussion purpose, a concept of “coherent antenna group” is used in this disclosure. Coherent antenna group is defined as: all antenna ports within a same coherent antenna group are coherent, which means that all the antenna ports within the same coherent antenna group can be used for transmission of one PUSCH layer, and that antenna ports from different coherent antenna groups are non-coherent, which means that antenna ports from different coherent antenna groups cannot be used for transmission of one PUSCH layer.

All the antenna ports within one coherent antenna group (which means that these antenna ports are coherent antenna ports) can be used for transmission of one PUSCH layer. Different coherent antenna groups can be used for transmission of different PUSCH layers.

From the channel estimation point of view, the phase difference between coherent antennas for a certain channel condition is fixed. Thus, co-phase based precoding on the coherent antenna port transmission is supported on the precoding design. However, the phase difference between non-coherent antenna ports is random. So, non-coherent antenna ports cannot be used for co-phase based transmission. Therefore, a PUSCH layer can only be transmitted on a set of coherent antenna ports.

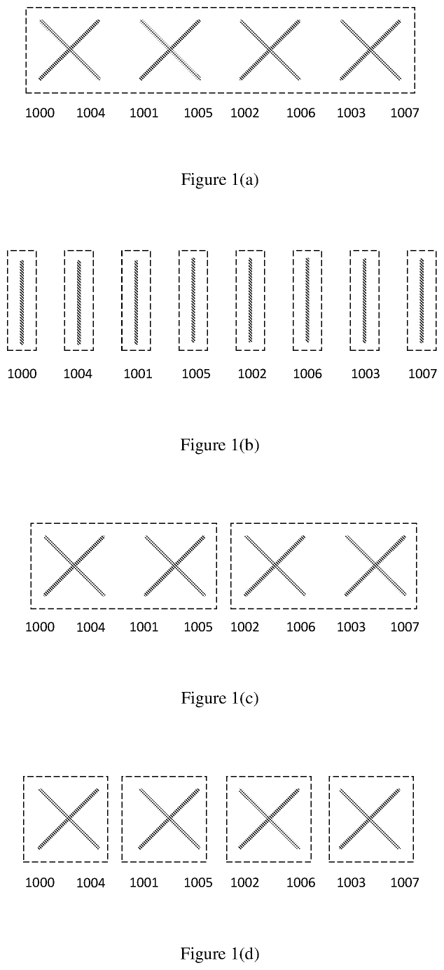

FIGS. 1(a) to 1(d) illustrate different antenna layouts for 8 antenna ports. The 8 antenna ports may be numbered as antenna ports 1000, 1001, 1002, 1003, 1004, 1005, 1006, and 1007.

FIG. 1(a) illustrates fully coherent antenna layout, in which all antenna ports 1000, 1001, 1002, 1003, 1004, 1005, 1006, and 1007 belong to one coherent antenna group. That is, there is one coherent antenna group in the fully coherent antenna layout, where the one coherent antenna group contains eight antenna ports.

FIG. 1(b) illustrates non-coherent antenna layout, in which each of antenna ports 1000, 1001, 1002, 1003, 1004, 1005, 1006, and 1007 belongs to a different coherent antenna group. That is, there are eight coherent antenna groups in the non-coherent antenna layout, where each of the eight coherent antenna groups contains one antenna port.

FIG. 1(c) illustrates partial-coherent antenna layout 1, in which four antenna ports (e.g. antenna ports 1000, 1001, 1004, and 1005) belong to one coherent antenna group, and the other four antenna ports (e.g. antenna ports 1002, 1003, 1006, and 1007) belong to the other coherent antenna group. That is, there are two coherent antenna groups in the partial-coherent antenna layout 1, where each of the two coherent antenna groups contains four antenna ports.

FIG. 1(d) illustrates partial-coherent antenna layout 2, in which two antenna ports belong to one coherent antenna group. For example, antenna ports 1000 and 1004 belong to a first coherent antenna group; antenna ports 1001 and 1005 belong to a second coherent antenna group; antenna ports 1002 and 1006 belong to a third coherent antenna group; and antenna ports 1003 and 1007 belong to a fourth coherent antenna group. That is, there are four coherent antenna groups in the partial-coherent antenna layout 2, where each of the four coherent antenna groups contains two antenna ports.

A first embodiment relates to one SRS resource being used to sound 8 antenna ports in one symbol.

For the case that 8 antenna ports are sounded by a same SRS resource in one symbol, one SRS resource set containing one or two SRS resources, each of which is configured with a UL TCI state to determine a different UL TX spatial filter for the SRS resource transmission to support beam-selection based UL transmission, can be configured for a UE in a BWP of a serving cell for single TRP scenario, where each SRS resource has 8 SRS ports for codebook.

It is necessary to determine the CS and/or comb offset for each SRS port of each SRS resource. It is proposed that different antenna ports within a same coherent antenna group occupy a same Comb offset but with different CSs, while different antenna ports from different coherent antenna port groups occupy different Comb offsets. In particular, two options (options 11 and 12) are provided below.

### Option 11:

For K_{TC}=2, n_{SRS}^{cs,max}=8, 2 comb offsets and 4 CSs are provided for 8 Tx ports. In particular,

$${n}_{SRS}^{cs , i} = ( {n}_{SRS}^{cs} + \frac{{n}_{SRS}^{cs , max} ⌊ ( {p}_{i} - 10 \; 00 ) / 2 ⌋}{{N}_{ap}^{SRS} / 2} ) mod {n}_{SRS}^{cs , max} , and$$

$${k}_{TC}^{( {p}_{i} )} = \{ \begin{matrix}( {\overline{k}}_{TC} + {K}_{TC} / 2 ) mod {K}_{TC} & {p}_{i} ∈ \{ 10 \; 01 , 1003 , 10 \; 05 , 1007 \} \\ {\overline{k}}_{TC} & {p}_{i} ∈ \{ 10 \; 00 , 1002 , 10 \; 04 , 1006 \}\end{matrix} ,$$

where i (=pᵢ−1000) is from 0 to 7, n_{SRS}^{cs}∈{0, 1, 2, 3, 4, 5, 6, 7}, k̅_{TC}∈{0, 1}, n_{SRS}^{cs} and k̅_{TC} are contained in the higher layer parameter transmissionComb configured for the SRS resource, Nₐₚ^{SRS}=8 is the number of antenna ports of the UE.

For K_{TC}=4, n_{SRS}^{cs,max}=12, two schemes are proposed:

Scheme 11:2 comb offsets and 4 CSs are provided for 8 Tx ports.

In particular,

$${n}_{SRS}^{cs , i} = ( {n}_{SRS}^{cs} + \frac{{n}_{SRS}^{cs , max} ⌊ ( {p}_{i} - 10 \; 00 ) / 2 ⌋}{{N}_{ap}^{SRS} / 2} ) mod {n}_{SRS}^{cs , max} , and$$

$${k}_{TC}^{( {p}_{i} )} = \{ \begin{matrix}( {\overline{k}}_{TC} + {K}_{TC} / 2 ) mod {K}_{TC} & {p}_{i} ∈ \{ 10 \; 01 , 1003 , 10 \; 05 , 1007 \} \\ {\overline{k}}_{TC} & {p}_{i} ∈ \{ 10 \; 00 , 1002 , 10 \; 04 , 1006 \}\end{matrix} ,$$

where i (=pᵢ−1000) is from 0 to 7, n_{SRS}^{cs}∈{0, 1, 2, 3, 4, 5, 6, 7, 8, 9, 10, 11}, k̅_{TC}∈{0, 1, 2, 3}, n_{SRS}^{cs} and k̅_{TC} are contained in the higher layer parameter transmissionComb configured for the SRS resource, Nₐₚ^{SRS}=8 is the number of antenna ports of the UE.

Scheme 12:4 comb offsets and 4 CSs are provided for 8 Tx ports.

In particular, if n_{SRS}^{cs}<6,

$${n}_{SRS}^{cs , i} = ( {n}_{SRS}^{cs} + \frac{{n}_{SRS}^{cs , max} ⌊ ( {p}_{i} - 10 \; 00 ) / 2 ⌋}{{N}_{ap}^{SRS} / 2} ) mod {n}_{SRS}^{cs , max} , and$$

$${k}_{TC}^{( {p}_{i} )} = \{ \begin{matrix}( {\overline{k}}_{TC} + {K}_{TC} / 2 ) mod {K}_{TC} & {p}_{i} ∈ \{ 10 \; 01 , 1003 , 10 \; 05 , 1007 \} \\ {\overline{k}}_{TC} & {p}_{i} ∈ \{ 10 \; 00 , 1002 , 10 \; 04 , 1006 \}\end{matrix} ,$$

where i (=pᵢ−1000) is from 0 to 7, n_{SRS}^{cs}∈{0, 1, 2, 3, 4, 5}, k̅_{TC}∈{0, 1, 2, 3}, n_{SRS}^{cs} and k̅_{TC} are contained in the higher layer parameter transmissionComb configured for the SRS resource, Nₐₚ^{SRS}=8 is the number of antenna ports of the UE,
otherwise (i.e. if n_{SRS}^{cs}>=6),

$${n}_{SRS}^{cs , i} = ( {n}_{SRS}^{cs} + \frac{{n}_{SRS}^{cs , max} ⌊ ( {p}_{i} - 10 \; 00 ) / 2 ⌋}{{N}_{ap}^{SRS} / 2} ) mod {n}_{SRS}^{cs , max} and$$

$${k}_{TC}^{( {p}_{i} )} = \{ \begin{matrix}{\overline{k}}_{TC} & {p}_{i} ∈ \{ 10 \; 00 , 1001 \} \\ ( {\overline{k}}_{TC} + 1 ) mod {K}_{TC} & {p}_{i} ∈ \{ 10 \; 02 , 1003 \} \\ ( {\overline{k}}_{TC} + 2 ) mod {K}_{TC} & {p}_{i} ∈ \{ 10 \; 04 , 1005 \} \\ ( {\overline{k}}_{TC} + 3 ) mod {K}_{TC} & {p}_{i} ∈ \{ 10 \; 06 , 1007 \}\end{matrix} ,$$

where i (=pᵢ−1000) is from 0 to 7, n_{SRS}^{cs}∈{6, 7, 8, 9, 10, 11}, k̅_{TC}∈{0, 1, 2, 3}, n_{SRS}^{cs} and k̅_{TC} are contained in the higher layer parameter transmissionComb configured for the SRS resource, Nₐₚ^{SRS}=8 is the number of antenna ports of the UE.

For K_{TC}=8, n_{SRS}^{cs,max}=6, 4 comb offsets and 2 CSs are provided for 8 Tx ports.

In particular,

$${n}_{SRS}^{cs , i} = ( {n}_{SRS}^{cs} + \frac{{n}_{SRS}^{cs , max} ⌊ ( {p}_{i} - 10 \; 00 ) / 2 ⌋}{{N}_{ap}^{SRS} / 2} ) mod {n}_{SRS}^{cs , max} , and$$

$${k}_{TC}^{( {p}_{i} )} = \{ \begin{matrix}{\overline{k}}_{TC} & {p}_{i} ∈ \{ 10 \; 00 , 1001 \} \\ ( {\overline{k}}_{TC} + 2 ) mod {K}_{TC} & {p}_{i} ∈ \{ 10 \; 02 , 1003 \} \\ ( {\overline{k}}_{TC} + 4 ) mod {K}_{TC} & {p}_{i} ∈ \{ 10 \; 04 , 1005 \} \\ ( {\overline{k}}_{TC} + 6 ) mod {K}_{TC} & {p}_{i} ∈ \{ 10 \; 06 , 1007 \}\end{matrix} ,$$

where i is from 0 to 7, n_{SRS}^{cs}∈{0, 1, 2, 3, 4, 5}, k̅_{TC}∈{0, 1, 2, 3, 4, 5, 6, 7}, n_{SRS}^{cs} and k̅_{TC} are contained in the higher layer parameter transmissionComb configured for the SRS resource, Nₐₚ^{SRS}=8 is the number of antenna ports of the UE.

### Option 12:

For K_{TC}=2, n_{SRS}^{cs,max}=8, antenna ports 1000, 1001, 1004 and 1005 are located in {n_{SRS}^{cs}, (n_{SRS}^{cs}+2)mod n_{SRS}^{cs,max}, (n_{SRS}^{cs}+4)mod n_{SRS}^{cs,max}, (n_{SRS}^{cs}+6)mod n_{SRS}^{cs,max}} with k̅_{TC}; and antenna ports 1002, 1003, 1006 and 1007 are located in {n_{SRS}^{cs} mod n_{SRS}^{cs,max}, (n_{SRS}^{cs}+2)mod n_{SRS}^{cs,max}, (n_{SRS}^{cs}+4)mod n_{SRS}^{cs,max}, (n_{SRS}^{cs}+6)mod n_{SRS}^{cs,max}} with (k̅_{TC}+1)mod K_{TC}, where n_{SRS}^{cs}∈{0, 1, 2, 3, 4, 5, 6, 7}, k̅_{TC}∈{0, 1}, n_{SRS}^{cs} and k̅_{TC} are contained in the higher layer parameter transmissionComb configured for the SRS resource.

For K_{TC}=4, n_{SRS}^{cs,max}=12, two schemes are proposed:

Scheme 21: antenna ports 1000, 1001, 1004 and 1005 are located in {n_{SRS}^{cs}, (n_{SRS}^{cs}+3)mod n_{SRS}^{cs,max} (n_{SRS}^{cs}+6)mod n_{SRS}^{cs,max}, (n_{SRS}^{cs}+9)mod n_{SRS}^{cs,max}} with k̅_{TC}; and antenna ports 1002, 1003, 1006 and 1007 are located in {n_{SRS}^{cs}, (n_{SRS}^{cs}+3)mod n_{SRS}^{cs,max} (n_{SRS}^{cs}+6)mod n_{SRS}^{cs,max}, (n_{SRS}^{cs}+9)mod n_{SRS}^{cs,max}} with (k̅_{TC}+2)mode K_{TC}, where n_{SRS}^{cs}∈{0, 1, 2, 3, 4, 5, 6, 7, 8, 9, 10, 11}, k̅_{TC}∈{0, 1, 2, 3}, n_{SRS}^{cs} and k̅_{TC} are contained in the higher layer parameter transmissionComb configured for the SRS resource.

### Scheme 22:

If n_{SRS}^{cs}<6, antenna ports 1000, 1001, 1004 and 1005 are located in {n_{SRS}^{cs}, (n_{SRS}^{cs}+3)mod n_{SRS}^{cs,max}, (n_{SRS}^{cs}+6)mod n_{SRS}^{cs,max}, (n_{SRS}^{cs}+9)mod n_{SRS}^{cs,max}} with k̅_{TC}; and antenna ports, 1002, 1003, 1006 and 1007 are located in {n_{SRS}^{cs}, (n_{SRS}^{cs}+3)mod n_{SRS}^{cs,max}, (n_{SRS}^{cs}+6)mod n_{SRS}^{cs,max}, (n_{SRS}^{cs}+9)mod n_{SRS}^{cs,max}} with (k̅_{TC}+2)mode K_{TC}, where n_{SRS}^{cs}∈{0, 1, 2, 3, 4, 5}, k̅_{TC}∈{0, 1, 2, 3}, n_{SRS}^{cs} and k̅_{TC} are contained in the higher layer parameter transmissionComb configured for the SRS resource.

If n_{SRS}^{cs}>=6, antenna ports 1000 and 1002 are located in {n_{SRS}^{cs}, (n_{SRS}^{cs}+6)mod n_{SRS}^{cs,max}} with k̅_{TC}; antenna ports 1001 and 1003 are located in {(n_{SRS}^{cs}+3)mod n_{SRS}^{cs,max}, (n_{SRS}^{cs}+9) mod n_{SRS}^{cs,max}} with (k̅_{TC}+1)mode K_{TC}; antenna ports 1004 and 1006 are located in {n_{SRS}^{cs}, (n_{SRS}^{cs}+6) n_{SRS}^{cs,max}} with (k̅_{TC}+2)mode K_{TC}; antenna ports 1005 and 1007 are located in {(n_{SRS}^{cs}+3)mod n_{SRS}^{cs,max}, (n_{SRS}^{cs}+9)mod n_{SRS}^{cs,max}} with (k̅_{TC}+3)mode K_{TC}, where n_{SRS}^{cs}∈{6, 7, 8, 9, 10, 11}, k̅_{TC}∈{0, 1, 2, 3}, n_{SRS}^{cs} and k̅_{TC} are contained in the higher layer parameter transmissionComb configured for the SRS resource.

For K_{TC}=8, n_{SRS}^{cs,max}=6, antenna ports 1000 and 1002 are located in {n_{SRS}^{cs}, (n_{SRS}^{cs}+3) mod n_{SRS}^{cs,max}} with k̅_{TC}; antenna ports 1001 and 1003 are located in {n_{SRS}^{cs}, (n_{SRS}^{cs}+3)mod n_{SRS}^{cs,max}} with (k̅_{TC}+2)mod K_{TC}; antenna ports 1004 and 1006 are located in {n_{SRS}^{cs}, (n_{SRS}^{cs}+3)mod n_{SRS}^{cs,max}} with (k̅_{TC}+4)mod K_{TC}; antenna ports 1005 and 1007 are located in {n_{SRS}^{cs}, (n_{SRS}^{cs}+3)mod n_{SRS}^{cs,max}} with (k̅_{TC}+6)mode K_{TC}, where n_{SRS}^{cs}∈{0, 1, 2, 3, 4, 5}, k̅_{TC}∈{0, 1, 2, 3, 4, 5, 6, 7}, n_{SRS}^{cs} and k̅_{TC} are contained in the higher layer parameter transmissionComb configured for the SRS resource.

Each SRS resource with 8 SRS ports will occupy 8 orthogonal resources. However, the total number of orthogonal resources for each comb size, i.e., the SRS capacity, is limited. For example, only 16 available orthogonal resources can be used for all SRS resources or for group of UEs in a same zone. So, the SRS capacity need to be further improved.

One solution is to enable larger number of cyclic shifts for each comb size. For example, the maximum number of cyclic shifts can be 12 for all Comb size. Then the schemes applied for Comb-4 can be adopted for K_{TC}=8. n_{SRS}^{cs,max}=12 as well. However, the minimal length of SRS sequence should be larger than or equal to 12.

A second embodiment relates to multiple SRS resources being used to sound 8 antenna ports in multiple symbols, where each SRS resource is transmitted in one symbol. For example, two SRS resources each with 4 SRS ports or four SRS resources each with 2 SRS ports can be used to sound 8 antenna ports where each SRS resource is transmitted in one symbol.

The second embodiment can be used for the UE with partial-coherent or non-coherent antenna capability. Since the channel condition corresponding to different coherent antenna groups are independent and the phase difference between different antennas within different coherent antenna groups are random, the channel matrix corresponding to different coherent antenna group can be sounded by different SRS resources in different symbols. The channel conditions corresponding to different antennas within a same coherent antenna group are correlated and the phase difference between different antennas within a same coherent antenna group is fixed for a channel. Accordingly, the channels for antennas within a same coherent antenna group should be sounded together by a same SRS resource.

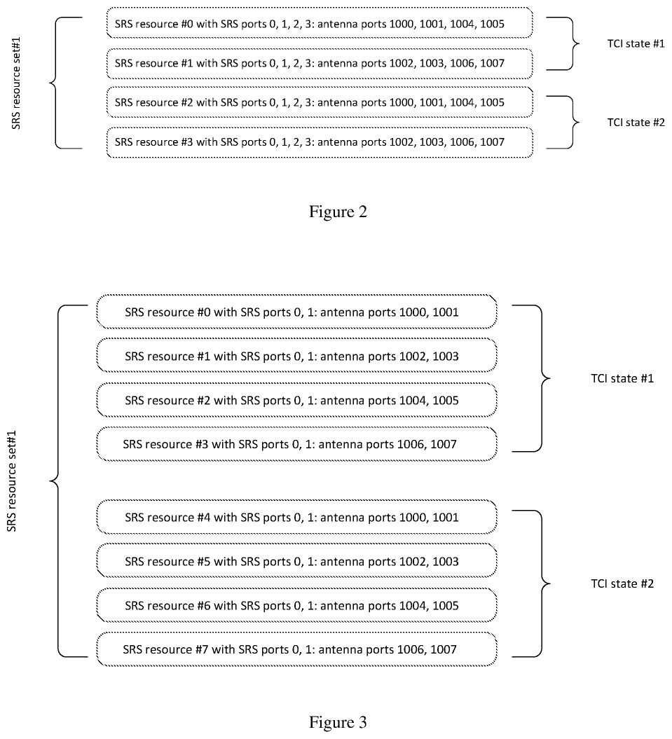

FIG. 2 illustrates a configuration of an SRS resource set (e.g. SRS resource set #1) for 8 Tx UE with 4 SRS resources each with 4 SRS ports. SRS resources #0 and #1 are associated with TCI state #1, and SRS resources #2 and #3 are associated with TCI state #2. TCI state #1 and TCI state #2 are respectively used to determine two different spatial domain Tx filters for the SRS transmission. Accordingly, two SRS resources each with 4 SRS ports are used to sound 8 antenna ports associated with one TCI state. SRS resources #0 and #1 each with 4 SRS ports are used to sound 8 antenna ports associated with TCI state #1, and SRS resources #2 and #3 each with 4 SRS ports are used to sound 8 antenna ports associated with TCI state #2.

For TCI state #1, antenna ports 1000, 1001, 1004, 1005 belonging to a first coherent antenna group are sounded by SRS resource #0 with SRS ports 0, 1, 2, 3, and antenna ports 1002, 1003, 1006, 1007 belonging to a second coherent antenna group are sounded by SRS resource #1 with SRS ports 0, 1, 2, 3; while SRS ports of SRS resource #0 and SRS ports of SRS resource #1 share the same comb offset and the same CS, i.e. the same n_{SRS}^{cs} and k̅_{TC} are contained in the higher layer parameter transmissionComb configured for SRS resource #0 and SRS resource #1, but occupy different symbols (e.g. SRS resource #0 is transmitted in symbol #n and SRS resource #1 is transmitted in symbol #n+1). In other words, SRS ports 0, 1, 2, 3 of SRS resource #0 are mapped to antenna ports 1000, 1001, 1004, 1005, and SRS ports 0, 1, 2, 3 of SRS resource #1 are mapped to antenna ports 1002, 1003, 1006, 1007. It can be seen that SRS resource #0 and SRS resource #1 are associated with different antenna ports in different symbols.

Similarly, for TCI state #2, SRS ports 0, 1, 2, 3 of SRS resource #2 are mapped to antenna ports 1000, 1001, 1004, 1005, and SRS ports 0, 1, 2, 3 of SRS resource #3 are mapped to antenna ports 1002, 1003, 1006, 1007.

Different from SRS for antenna switching, a gap is not needed among different SRS resources (e.g. between SRS resource #0 and SRS resource #1). In addition, the antenna ports within a same coherent antenna group should be associated with a same SRS resource. That is, antenna ports 1000, 1001, 1004, 1005 that belong to a first coherent antenna group are associated with SRS ports 0, 1, 2, 3 of SRS resource #0, and antenna ports 1002, 1003, 1006, 1007 that belong to a second coherent antenna group are associated with SRS ports 0, 1, 2, 3 of SRS resource #1.

FIG. 3 illustrates a configuration of an SRS resource set (e.g. SRS resource set #1) for 8 Tx UE with 8 SRS resources each with 2 SRS ports. SRS resources #0, #1, #2 and #3 are associated with TCI state #1, and SRS resources #4, #5, #6 and #7 are associated with TCI state #2. Accordingly, SRS resources #0, #1, #2 and #3 each with 2 SRS ports are used to sound 8 antenna ports associated with TCI state #1, and SRS resources #4, #5, #6 and #7 each with 4 SRS ports are used to sound 8 antenna ports associated with TCI state #2.

For TCI state #1, antenna ports 1000, 1001 belonging to a first coherent antenna group are sounded by SRS resource #0 with SRS ports 0, 1, antenna ports 1002, 1003 belonging to a second coherent antenna group are sounded by SRS resource #1 with SRS ports 0, 1, antenna ports 1004, 1005 belonging to a third coherent antenna group are sounded by SRS resource #2 with SRS ports 0, 1, antenna ports 1006, 1007 belonging to a fourth coherent antenna group are sounded by SRS resource #3 with SRS ports 0, 1; while SRS ports of SRS resource #0, SRS ports of SRS resource #1, SRS ports of SRS resource #2 and SRS ports of SRS resource #3 share the same comb offset and the same CS, i.e. the same n_{SRS}^{cs} and k̅_{TC} are contained in the higher layer parameter transmissionComb configured for SRS resource #0, SRS resource #1, SRS resource #2 and SRS resource #1, but occupy different symbols (e.g. SRS resource #0 is transmitted in symbol #n, SRS resource #1 is transmitted in symbol #n+1, SRS resource #2 is transmitted in symbol #n+2, and SRS resource #3 is transmitted in symbol #n+3). In other words, SRS ports 0, 1 of SRS resource #0 are mapped to antenna ports 1000, 1001, SRS ports 0, 1 of SRS resource #1 are mapped to antenna ports 1002, 1003, SRS ports 0, 1 of SRS resource #2 are mapped to antenna ports 1004, 1005, SRS ports 0, 1 of SRS resource #3 are mapped to antenna ports 1006, 1007.

Similarly, for TCI state #2, SRS ports 0, 1 of SRS resource #4 are mapped to antenna ports 1000, 1001, SRS ports 0, 1 of SRS resource #5 are mapped to antenna ports 1002, 1003, SRS ports 0, 1 of SRS resource #6 are mapped to antenna ports 1004, 1005, SRS ports 0, 1 of SRS resource #7 are mapped to antenna ports 1006, 1007.

Different from SRS for antenna switching, a gap is not needed among different SRS resources (e.g. between SRS resource #0 and SRS resource #1, between SRS resource #1 and SRS resource #2, and between SRS resource #2 and SRS resource #3). In addition, the antenna ports within a same coherent antenna group should be associated with a same SRS resource. That is, antenna ports 1000, 1001 that belong to a first coherent antenna group are associated with SRS port 0 and SRS port 1 of SRS resource #0, antenna ports 1002, 1003 that belong to a second coherent antenna group are associated with SRS port 0 and SRS port 1 of SRS resource #1, antenna ports 1004, 1005 that belong to a third coherent antenna group are associated with SRS port 0 and SRS port 1 of SRS resource #2, antenna ports 1006, 1007 that belong to a fourth coherent antenna group are associated with SRS port 0 and SRS port 1 of SRS resource #3.

In the example of FIG. 3, at least 8 adjacent symbols are required for transmission all 8 SRS resources (i.e. SRS resources #0 to #7) within the SRS resource set #1. This configuration is invalid for a UE that can only transmit SRS in the last 6 symbols in a slot, since all the 8 SRS resources within an SRS resource set cannot be transmitted within a same slot. For this type of UE (that can only transmit SRS in the last 6 symbols in a slot), all the 8 SRS resources can be configured within two SRS resource sets where each SRS resource set consists of 4 SRS resources.

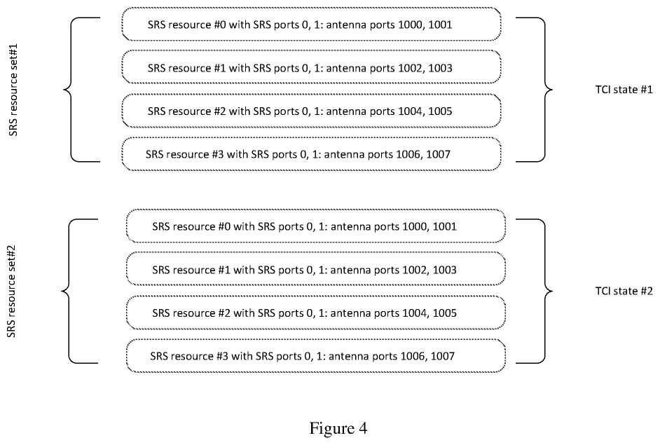

FIG. 4 illustrates a configuration of two SRS resource sets (e.g. SRS resource set #1 and SRS resource set #2) for 8 Tx UE each with 4 SRS resources each with 2 SRS ports.

All SRS resources (e.g. SRS resources #0 to #3) within the first SRS resource set (e.g. SRS resource set #1) are transmitted in a slot for sounding all the 8 antenna ports associated with a first UL TCI state (e.g. TCI state #1), and all SRS resources (e.g. SRS resources #0 to #3) within the second SRS resource set (e.g. SRS resource set #2) are transmitted in another slot for sounding all the 8 antenna ports associated with a second UL TCI state (e.g. TCI state #2).

Both SRS resource sets (e.g. SRS resource set #1 and SRS resource set #2) should be configured with a same set of power control parameters. In addition, both SRS resource sets should be configured with the same time domain behavior. For example, when both SRS resource sets are configured as aperiodic, they should be triggered by a same SRS request codepoint to ensure that all SRS resources can be simultaneously triggered for transmission. For another example, when both SRS resource sets are configured as semi-persistent, they should be activated or deactivated by a same MAC CE.

To quickly obtain a more completed channel matrix, SRS resources sounding for all 8 antenna ports are expected to be configured to be transmitted on 2 adjacent symbols with 2 SRS resources or on 4 adjacent symbols with 4 SRS resources. The two or four SRS resources for sounding all 8 antenna ports are defined as an SRS group. For a first example as shown in FIG. 2, SRS resource 0 and SRS resource 1 belong to SRS group 0, and SRS resource 2 and SRS resource 3 belong to SRS group 1. For a second example as shown in FIG. 3, SRS resource 0, 1, 2, 3 belong to SRS group 0, SRS resource 4, 5, 6, 7 belong to SRS group 1. For a third example as shown in FIG. 4, SRS resource 0, 1, 2, 3 belong to SRS group 0, SRS resource 4, 5, 6, 7 belong to SRS group 1. Incidentally, in the example of FIG. 4, an SRS group is equivalent to an SRS resource set.

When at least one of the symbols used for transmission of SRS resource(s) within an SRS group is dropped due to signal collision (e.g. a PUCCH resource is scheduled to be transmitted in at least one of the symbols for SRS transmission), all the SRS resources within the SRS group are dropped.

When frequency hopping or repetition are configured for the SRS resource, the same frequency hopping (FH) parameters and/or repetition factors should be configured for the SRS resources within a same SRS group. Besides, the frequency hopping or repetition should be performed per SRS group. It means that the SRS resources within a same SRS group shall be hopped or repeated together.

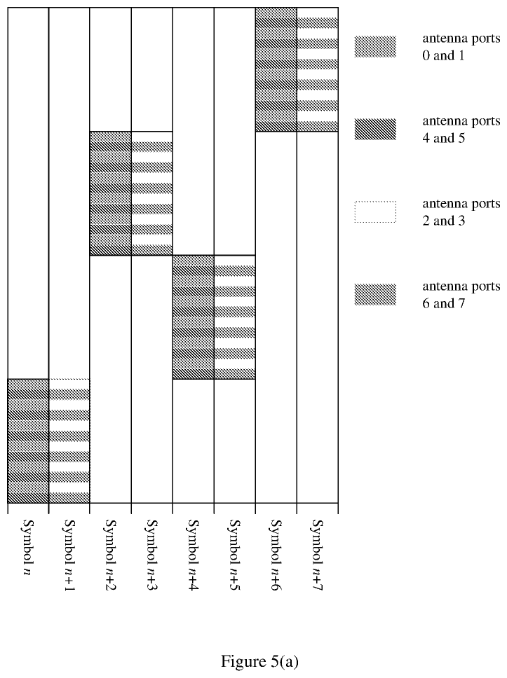

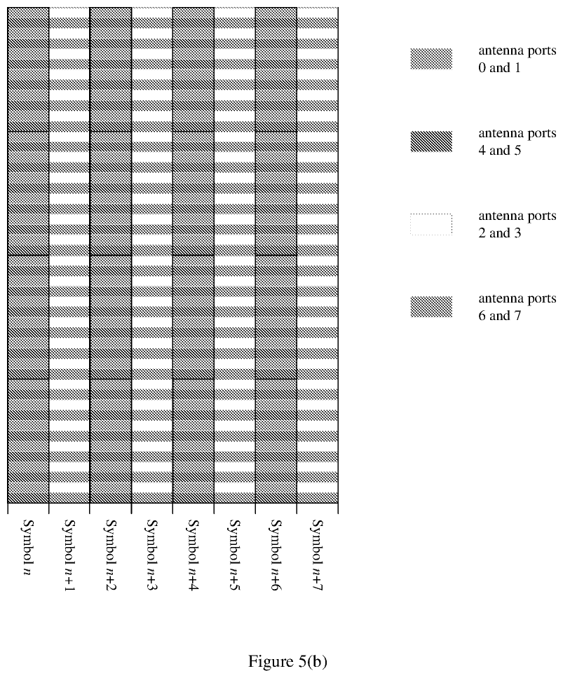

An example for frequency hopping is shown in FIG. 5(a), and an example for frequency repetition is shown in FIG. 5(b). In each of FIG. 5(a) and FIG. 5(b), all 8 antenna ports are sounded by two SRS resources in two adjacent symbols. The two SRS resources belong to one SRS group. As shown in FIG. 5(a), the frequency hopping is performed per SRS group (i.e. per two SRS resources): from a first frequency band in symbols n and n+1, hopping to a second frequency band in symbols n+2 and n+3, hopping to a third frequency band in symbols n+4 and n+5, and hopping to a fourth frequency band in symbols n+6 and n+7. As shown in FIG. 5(b), the two SRS resources (belonging to one SRS group) are repeated in symbols n and n+1, symbols n+2 and n+3, symbols n+4 and n+5 and symbols n+6 and n+7.

The indication of the SRS resources for 8-ports PUSCH transmission is described as follows:

In the condition that one SRS resource set is configured, 8 SRS ports shall be indicated by the SRS resource indicator (SRI) field in the scheduling DCI (the DCI scheduling PUSCH transmission). Since the 8 SRS ports are associated with multiple SRS resources (e.g. 2 SRS resources or 4 SRS resources) within the one SRS resource set associated with each UL TCI state, multiple SRS resources shall be indicated by the SRI field. Two options (Options 21 and 22) are proposed.

Option 21: each SRS resource corresponds to an SRI value. It means that each SRI indicates one SRS resource. Each SRS resource indicator field value is mapped to multiple (e.g. 2 or 4) SRI values that indicate multiple (e.g. 2 or 4) SRS resources associated with a UL TCI state and for all 8 antenna ports.

Table 2 can be used for 8 antenna ports being sounded by two SRS resources associated with a UL TCI state.

TABLE 2
SRI indication for codebook based PUSCH transmission
(8 antenna ports being sounded by two SRS resources
associated with a UL TCI state)

| SRS resource indicator field value | SRI(s) |
|---|---|
| 0 | 0, 1 |
| 1 | 2, 3 |

Table 3 can be used for 8 antenna ports being sounded by four SRS resources associated with a UL TCI state.

TABLE 3
SRI indication for codebook based PUSCH transmission
(8 antenna ports being sounded by four SRS resources
associated with a UL TCI state)

| SRS resource indicator field value | SRI(s) |
|---|---|
| 0 | 0, 1, 2, 3 |
| 1 | 4, 5, 6, 7 |

Option 22: Each SRS resource indicator field value indicates an SRI value that indicates multiple (e.g. 2 or 4) SRS resources associated with a UL TCI state and for sounding all 8 antenna ports. In other words, each SRI value indicates all the SRS resources within one SRS group.

For a first example, if an SRS group consists of 2 SRS resources (e.g. in the example of FIG. 2, a first SRS group consists of SRS resources #0 and #1 associated with TCI state #1, and a second SRS group consists of SRS resources #2 and #3 associated with TCI state #2), SRI value 0 is associated with the first and the second SRS resources in the one SRS resource set (e.g. SRS resources #0 and #1 in the example shown in FIG. 2), and SRI value 1 is associated with the third and the fourth SRS resources in the one SRS resource set (e.g. SRS resources #2 and #3 in the example shown in FIG. 2). The 2 SRS resources indicated by an SRI value are further associated with an 8-ports virtual SRS resource used for PUSCH transmission. For example, a first 8-ports virtual SRS resource is associated with the first and the second SRS resources, and a second 8-ports virtual SRS resource is associated with the third and the fourth SRS resources. The SRS ports 0, 1, 2, 3, 4, 5, 6, 7 of each virtual SRS resource are mapped to antenna ports 1000, 1001, 1002, 1003, 1004, 1005, 1006, 1007, respectively, and are used for PUSCH transmission. Further, SRS port 0, 1, 2, 3 of SRS resource #0 are mapped to SRS port 0, 1, 2, 3 of the first virtual SRS resource, and SRS port 0, 1, 2, 3 of SRS resource #1 are mapped to SRS port 4, 5, 6, 7 of the first virtual SRS resource. SRS port 0, 1, 2, 3 of SRS resource #2 are mapped to SRS port 0, 1, 2, 3 of the second virtual SRS resource, and SRS port 0, 1, 2, 3 of SRS resource #3 are mapped to SRS port 4, 5, 6, 7 of the second virtual SRS resource. The first virtual SRS resource applies the UL TCI state associated with the first SRS resource (as well as with the second SRS resource), and the second virtual SRS resource applies the UL TCI state associated with the third SRS resource (as well as with the fourth SRS resource).

For a second example, if an SRS group consists of 4 SRS resources (e.g. in the example of FIG. 3, a first SRS group consists of SRS resources #0, #1, #2 and #3 associated with TCI state #1, and a second SRS group consists of SRS resources #4, #5, #6 and #7 associated with TCI state #2), SRI value 0 is associated with the first, the second, the third and the fourth SRS resources in the one SRS resource set (e.g. SRS resources #0, #1, #2 and #3 in the example shown in FIG. 3), and SRI value 1 is associated with the fifth, the sixth, the seventh and the eighth SRS resources in the one SRS resource set (e.g. SRS resources #4, #5, #6 and #7 in the example shown in FIG. 3). The 4 SRS resources indicated by an SRI value are further associated with an 8-ports virtual SRS resource used for PUSCH transmission. For example, a first 8-ports virtual SRS resource is associated with the first, the second, the third and the fourth SRS resources, and a second 8-ports virtual SRS resource is associated with the fifth, the sixth, the seventh and the eighth SRS resources. The SRS ports 0, 1, 2, 3, 4, 5, 6, 7 of each virtual SRS resource are mapped to antenna ports 1000, 1001, 1002, 1003, 1004, 1005, 1006, 1007, respectively, and are used for PUSCH transmission. Further, SRS port 0, 1 of SRS resource #0 are mapped to SRS port 0, 1 of the first virtual SRS resource, and SRS port 0, 1 of SRS resource #1 are mapped to SRS port 2, 3 of the first virtual SRS resource, SRS port 0, 1 of SRS resource #2 are mapped to SRS port 4, 5 of the first virtual SRS resource, and SRS port 0, 1 of SRS resource #3 are mapped to SRS port 6, 7 of the first virtual SRS resource. SRS port 0, 1 of SRS resource #4 are mapped to SRS port 0, 1 of the second virtual SRS resource, and SRS port 0, 1 of SRS resource #5 are mapped to SRS port 2, 3 of the second virtual SRS resource, SRS port 0, 1 of SRS resource #6 are mapped to SRS port 4, 5 of the second virtual SRS resource, and SRS port 0, 1 of SRS resource #7 are mapped to SRS port 6, 7 of the second virtual SRS resource. The first virtual SRS resource applies the UL TCI state associated with the first SRS resource (as well as with the second, the third and the fourth SRS resources), and the second virtual SRS resource applies the UL TCI state associated with the fifth SRS resource (as well as with the sixth, the seventh and the eighth SRS resources).

Incidentally, for both options 21 and 22, the bitwidth of the SRS resource indicator (SRI) field in DCI format 0_1 or 0_2 is determined by

$$⌈ {log}_{2} ( \frac{{N}_{SRS}}{K} ) ⌉ ,$$

where N_{SRS} is the number of configured SRS resources in the SRS resource set and K is the number of SRS resources associated with one UL TCI state used for sounding all 8 SRS ports. It can be seen that K is also the number of SRS resources within one SRS group.

In the condition that multiple (e.g. two) SRS resource sets are configured, SRS resource set indicator (SRSI) field is used for indicating the SRS resources for PUSCH transmission. The SRS resource indicator field has ┌log₂(N_{SRS,set})┐ bits, where N_{SRS,set} is the number of SRS resource sets for codebook associated with one UL TCI state (e.g. for single-TRP). For example, if N_{SRS,set}=2, SRSI with value 0 is associated with all the SRS resources within a first SRS resource set, and SRSI with value 1 is associated with all the SRS resources within a second SRS resource set.

A third embodiment relates to one SRS resource being used to sound 8 antenna ports in multiple (e.g. two) symbols.

When a SRS resource is configured with 8 SRS ports, each pair of SRS ports can be multiplexed with TD-OCC code [1 1] and [1 −1] but share the same Comb offset and the same CS. Accordingly, each SRS resource occupies two adjacent symbols in the third embodiment.

For example, SRS ports 0, 1, 2, 3 are transmitted in both symbols with TD-OCC code [1 1], and SRS ports 4, 5, 6, 7 are transmitted in both symbols TD-OCC code [1 −1]. SRS ports 0, 1, 2, 3 are transmitted in both symbols with TD-OCC code [1 1] means that SRS sequence of each of SRS ports 0, 1, 2, 3 is firstly transmitted in the 1^{st} symbol by multiplying the first element of the assigned TD-OCC code, i.e., [1] and then transmitted in the 2^{nd} symbol by multiplying the second element of the assigned TD-OCC code, i.e., [1]. SRS ports 4, 5, 6, 7 are transmitted in both symbols with TD-OCC code [1 −1] means that SRS sequence of each of SRS ports 4, 5, 6, 7 is firstly transmitted in the 1^{st} symbol by multiplying the first element of the assigned TD-OCC code, i.e., [1] and then transmitted in the 2^{nd} symbol by multiplying the second element of the assigned TD-OCC code, i.e., [−1]. SRS port 0 and SRS port 4 are multiplexed with [1 1] and [1 −1] and share the same comb offset and the same CS (i.e., share the same subcarriers and the same SRS sequence), SRS port 1 and SRS port 5 are multiplexed with [1 1] and [1 −1] and share the same comb offset and the same CS (i.e., share the same subcarriers and the same SRS sequence), SRS port 2 and SRS port 6 are multiplexed with [1 1] and [1 −1] and share the same comb offset and the same CS (i.e., share the same subcarriers and the same SRS sequence), SRS port 3 and SRS port 7 are multiplexed with [1 1] and [1 −1] and share the same comb offset and the same CS (i.e., share the same subcarriers and the same SRS sequence). Each SRS resource occupies two adjacent symbols, e.g., symbol #n (which is indicated by RRC signaling for the SRS resource) and symbol #n+1. Two SRS ports are multiplexed with [1 1] and [1 −1] means that the SRS sequence of 1^{st} SRS port is transmitted on two symbols by multiplying [1] and [1], while the SRS sequence of the 2^{nd} SRS port is transmitted on the same two symbols by multiplying [1] and [−1], and the same set of subcarriers are occupied by the two SRS ports in both symbols.

Incidentally, when at least one of the symbols used for transmission of an SRS resource (e.g. with 8 SRS ports) is dropped due to signal collision (for example, a PUCCH resource is scheduled to be transmitted in at least one of the symbols for SRS transmission), the SRS resource on both symbols is dropped.

A fourth embodiment relates to SRS for non-codebook for 8 Tx.

To support 8 Tx non-codebook based PUSCH transmission, the straightforward method is to configure up to 8 single port SRS resources within an SRS resource set. For the UE that can only transmit SRS in the last 6 symbols in a slot, if only one SRS resource can be transmitted in one symbol, 8 symbols are required for transmission of all the 8 SRS resources. So, all the 8 SRS resources within the SRS resource set cannot be transmitted in a slot in this case. Accordingly, all the 8 SRS resources can be configured in two SRS resource sets.

When 8 SRS resources are required for non-codebook, two SRS resource sets (e.g. a first SRS resource set and a second SRS resource set) for non-codebook are configured, where the number of SRS resources configured for each of the first SRS resource set and the second SRS resource set shall be equal to or smaller than 6, while the total number of SRS resources each with one SRS port within the two SRS resource sets is equal to 8. For example, the numbers of SRS resources configured for the first SRS resource set and the second SRS resource set can be {4, 4} or {2, 6} or {6, 2}.

All the SRS resources within the two SRS resource sets are configured to be associated with a same UL TCI state.

Both SRS resource sets are configured with the same time domain behavior. For example, when both SRS resource sets are configured as aperiodic, they should be triggered by a same SRS request codepoint such that all the SRS resource in both SRS resource sets can be simultaneous triggered for transmission. For another example, when both SRS resource sets are configured as semi-persistent, they should be activated or deactivated by a same MAC CE.

Both SRS resource sets (i.e. all 8 SRS resources within the two SRS resource sets) are associated with a same NZP CSI-RS resource for precoding calculation. A 42-symbols gap between the last symbol of the reception of aperiodic NZP CSI-RS resource and the first symbol of the aperiodic SRS transmission in the first SRS resource set should be satisfied for the UE to calculate the precoder applied for the SRS transmission when aperiodic NZP CSI-RS is associated with aperiodic SRS resource sets for precoding calculation.

The indication of the SRS resources for 8-ports PUSCH transmission is described as follows:

One or more SRIs corresponding to one or more SRS resources can be indicated by the SRS resource indicator field in the scheduling DCI for the PUSCH transmission. The UE transmits 8 SRS resources to the gNB. The gNB can indicate one or multiple of the received SRS resources with a bitmap manner. In particular, bitmap based SRI indication is proposed. The maximum number of indicated SRS resources by the bitmap should be smaller than or equals to the configured rank restriction of the UE, i.e. the maximum rank for the PUSCH scheduling.

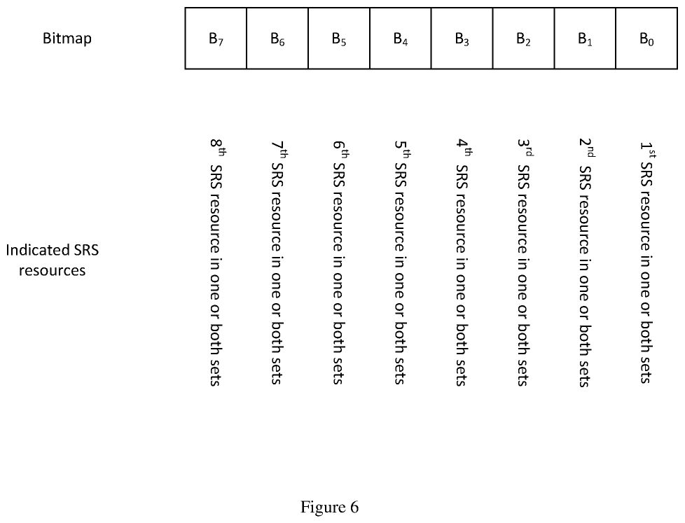

FIG. 6 illustrates an example of the bitmap based SRI indication. Each bit of the bitmap indicates an SRS resource.

The length of the bitmap is determined by the number of SRS resources configured in the one or two SRS resource sets for non-codebook. For example, the length of bitmap is 8 for configured two SRS resource sets for non-codebook. The bitmap is indicated by the SRS resource indicator (SRI) field in the scheduling DCI with format 0_1 or 0_2 or in the configured-grant (CG) configuration.

As illustrated in FIG. 6, Bᵢ of the bitmap indicates whether the (i+1)^{th} SRS resource configured in the one or two SRS resource sets are indicated for the PUSCH transmission. Bi=0 indicates the (i+1)^{th} SRS resource is selected for the scheduled PUSCH transmission, Bi=1 indicates the (i+1)^{th} SRS resource is not selected for the scheduled PUSCH transmission.

Alternatively, the N₁ LSB bits of the bitmap correspond to the N₁ SRS resources within the first SRS resource set and the N₂ MSB bits of the bitmap correspond to the N₂ SRS resources within the second SRS resource set.

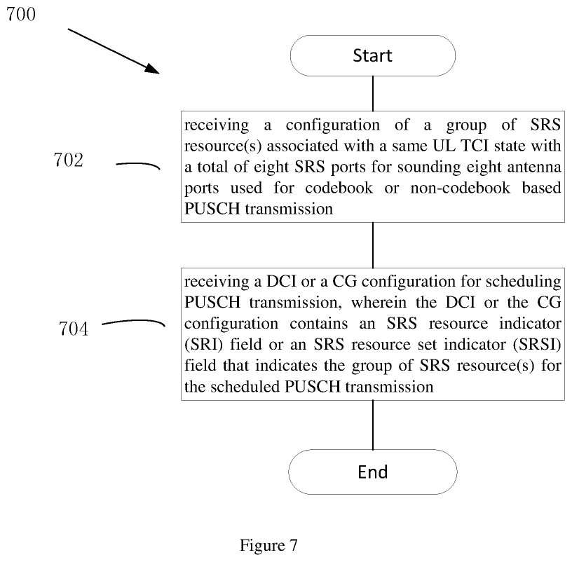

FIG. 7 is a schematic flow chart diagram illustrating an embodiment of a method 700 according to the present application. In some embodiments, the method 700 is performed by an apparatus, such as a remote unit (e.g. UE). In certain embodiments, the method 700 may be performed by a processor executing program code, for example, a microcontroller, a microprocessor, a CPU, a GPU, an auxiliary processing unit, a FPGA, or the like.

The method 700 is a method performed at a UE, comprising: 702 receiving a configuration of a group of SRS resource(s) associated with a same UL TCI state with a total of eight SRS ports for sounding eight antenna ports used for codebook or non-codebook based PUSCH transmission; and 704 receiving a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

In some embodiment, the group of SRS resource(s) is one SRS resource with eight SRS ports. The eight SRS ports of the one SRS resource may be transmitted in one symbol with different comb offsets and two or more different CS values. Alternatively, the eight SRS ports of the one SRS resource may be transmitted in two adjacent symbols. In this condition, each pair of SRS ports of the one SRS resource are multiplexed by TD-OCC [1 1] and [1 −1], and share the same comb offset and the same CS value. In addition, if one of the two symbols is dropped due to collision handling, the one SRS resource on the two symbols is dropped.

In some embodiment, the group of SRS resource(s) is two SRS resources each with four SRS ports, the four SRS ports of each SRS resource are associated with four antenna ports belonging to a different coherent antenna group. The SRS resource indicator field indicates an index corresponding to 2 SRI values, where each SRI value indicates one SRS resource, or the SRS resource indicator field indicates an SRI value that corresponds to 2 SRS resources.

In some embodiment, the group of SRS resource(s) is four SRS resources each with two SRS ports, the two SRS ports of each SRS resource are associated with two antenna ports belonging to a different coherent antenna group. The SRS resource indicator field indicates an index corresponding to 4 SRI values, where each SRI value indicates one SRS resource; or the SRS resource indicator field indicates an SRI value that corresponds to 4 SRS resources.

In the condition that the group of SRS resource(s) is two or four SRS resources each of which is transmitted in a different symbol, if at least one of the symbols for transmitting any of the SRS resources is dropped due to collision handling, the group of SRS resource(s) are dropped.

In some embodiment, the same frequency hopping parameters and/or the same repetition factors are configured for the SRS resources within an SRS group, and frequency hopping and/or frequency repetition are performed per SRS group of SRS resource(s).

In some embodiment, the group of SRS resource(s) is two SRS resource sets with a total of eight SRS resources each with one SRS port for non-codebook. If the two SRS resource sets are configured as aperiodic, the two aperiodic SRS resource sets are triggered by a same SRS request codepoint; and if the two SRS resource sets are configured as semi-persistent, the two semi-persistent SRS resource sets are activated or deactivated by a same MAC CE. The eight SRS resources within the two SRS resource sets may be associated with an aperiodic NZP CSI-RS resource, and a 42-symbols gap between the last symbol of the reception of the aperiodic NZP CSI-RS resource and the first symbol of the aperiodic SRS transmission in a first of the two SRS resource sets is satisfied.

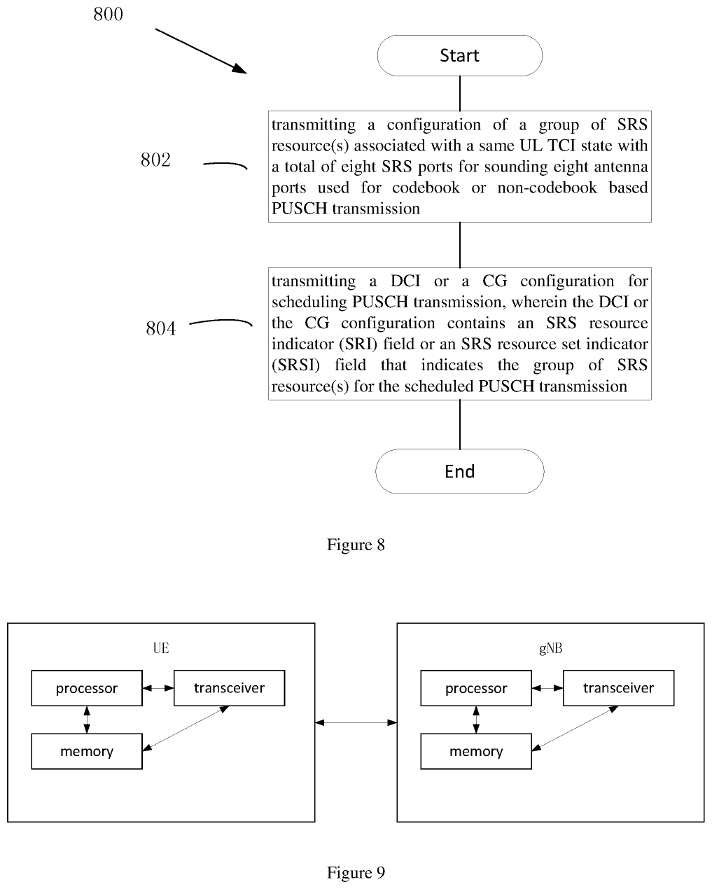

FIG. 8 is a schematic flow chart diagram illustrating an embodiment of a method 800 according to the present application. In some embodiments, the method 800 is performed by an apparatus, such as a base unit. In certain embodiments, the method 800 may be performed by a processor executing program code, for example, a microcontroller, a microprocessor, a CPU, a GPU, an auxiliary processing unit, a FPGA, or the like.

The method 800 may comprise 802 transmitting a configuration of a group of SRS resource(s) associated with a same UL TCI state with a total of eight SRS ports for sounding eight antenna ports used for codebook or non-codebook based PUSCH transmission; and 804 transmitting a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

In some embodiment, the group of SRS resource(s) is one SRS resource with eight SRS ports. The eight SRS ports of the one SRS resource may be received in one symbol with different comb offsets and two or more different CS values. Alternatively, the eight SRS ports of the one SRS resource may be received in two adjacent symbols. In this condition, each pair of SRS ports of the one SRS resource are multiplexed by TD-OCC [1 1] and [1 −1], and share the same comb offset and the same CS value. In addition, if one of the two symbols is dropped due to collision handling, the one SRS resource on the two symbols is dropped.

In some embodiment, the group of SRS resource(s) is two SRS resources each with four SRS ports, the four SRS ports of each SRS resource are associated with four antenna ports belonging to a different coherent antenna group. The SRS resource indicator field indicates an index corresponding to 2 SRI values, where each SRI value indicates one SRS resource, or the SRS resource indicator field indicates an SRI value that corresponds to 2 SRS resources.

In some embodiment, the group of SRS resource(s) is four SRS resources each with two SRS ports, the two SRS ports of each SRS resource are associated with two antenna ports belonging to a different coherent antenna group. The SRS resource indicator field indicates an index corresponding to 4 SRI values, where each SRI value indicates one SRS resource; or the SRS resource indicator field indicates an SRI value that corresponds to 4 SRS resources.

In the condition that the group of SRS resource(s) is two or four SRS resources each of which is received in a different symbol, if at least one of the symbols for receiving any of the SRS resources is dropped due to collision handling, the group of SRS resource(s) are dropped.

In some embodiment, the same frequency hopping parameters and/or the same repetition factors are configured for the SRS resources within an SRS group, and frequency hopping and/or frequency repetition are performed per SRS group of SRS resource(s).

In some embodiment, the group of SRS resource(s) is two SRS resource sets with a total of eight SRS resources each with one SRS port for non-codebook. If the two SRS resource sets are configured as aperiodic, the two aperiodic SRS resource sets are triggered by a same SRS request codepoint; and if the two SRS resource sets are configured as semi-persistent, the two semi-persistent SRS resource sets are activated or deactivated by a same MAC CE. The eight SRS resources within the two SRS resource sets may be associated with an aperiodic NZP CSI-RS resource, and a 42-symbols gap between the last symbol of the reception of the aperiodic NZP CSI-RS resource and the first symbol of the aperiodic SRS transmission in a first of the two SRS resource sets is satisfied.

FIG. 9 is a schematic block diagram illustrating apparatuses according to one embodiment.

Referring to FIG. 9, the UE (i.e. the remote unit) includes a processor, a memory, and a transceiver. The processor implements a function, a process, and/or a method which are proposed in FIG. 7.

The UE comprises a transceiver; and a processor coupled to the transceiver, wherein the processor is configured to receive, via the transceiver, a configuration of a group of SRS resource(s) associated with a same UL TCI state with a total of eight SRS ports for sounding eight antenna ports used for codebook or non-codebook based PUSCH transmission; and receive, via the transceiver, a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

In some embodiment, the group of SRS resource(s) is one SRS resource with eight SRS ports. The eight SRS ports of the one SRS resource may be transmitted in one symbol with different comb offsets and two or more different CS values. Alternatively, the eight SRS ports of the one SRS resource may be transmitted in two adjacent symbols. In this condition, each pair of SRS ports of the one SRS resource are multiplexed by TD-OCC [1 1] and [1 −1], and share the same comb offset and the same CS value. In addition, if one of the two symbols is dropped due to collision handling, the one SRS resource on the two symbols is dropped.

In some embodiment, the group of SRS resource(s) is two SRS resources each with four SRS ports, the four SRS ports of each SRS resource are associated with four antenna ports belonging to a different coherent antenna group. The SRS resource indicator field indicates an index corresponding to 2 SRI values, where each SRI value indicates one SRS resource, or the SRS resource indicator field indicates an SRI value that corresponds to 2 SRS resources.

In some embodiment, the group of SRS resource(s) is four SRS resources each with two SRS ports, the two SRS ports of each SRS resource are associated with two antenna ports belonging to a different coherent antenna group. The SRS resource indicator field indicates an index corresponding to 4 SRI values, where each SRI value indicates one SRS resource; or the SRS resource indicator field indicates an SRI value that corresponds to 4 SRS resources.

In the condition that the group of SRS resource(s) is two or four SRS resources each of which is transmitted in a different symbol, if at least one of the symbols for transmitting any of the SRS resources is dropped due to collision handling, the group of SRS resource(s) are dropped.

In some embodiment, the same frequency hopping parameters and/or the same repetition factors are configured for the SRS resources within an SRS group, and frequency hopping and/or frequency repetition are performed per SRS group of SRS resource(s).

In some embodiment, the group of SRS resource(s) is two SRS resource sets with a total of eight SRS resources each with one SRS port for non-codebook. If the two SRS resource sets are configured as aperiodic, the two aperiodic SRS resource sets are triggered by a same SRS request codepoint; and if the two SRS resource sets are configured as semi-persistent, the two semi-persistent SRS resource sets are activated or deactivated by a same MAC CE. The eight SRS resources within the two SRS resource sets may be associated with an aperiodic NZP CSI-RS resource, and a 42-symbols gap between the last symbol of the reception of the aperiodic NZP CSI-RS resource and the first symbol of the aperiodic SRS transmission in a first of the two SRS resource sets is satisfied.

The gNB (i.e. the base unit) includes a processor, a memory, and a transceiver. The processor implements a function, a process, and/or a method which are proposed in FIG. 8.

The base unit comprises a transceiver; and a processor coupled to the transceiver, wherein the processor is configured to transmit, via the transceiver, a configuration of a group of SRS resource(s) associated with a same UL TCI state with a total of eight SRS ports for sounding eight antenna ports used for codebook or non-codebook based PUSCH transmission; and transmit, via the transceiver, a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

In some embodiment, the group of SRS resource(s) is one SRS resource with eight SRS ports. The eight SRS ports of the one SRS resource may be received in one symbol with different comb offsets and two or more different CS values. Alternatively, the eight SRS ports of the one SRS resource may be received in two adjacent symbols. In this condition, each pair of SRS ports of the one SRS resource are multiplexed by TD-OCC [1 1] and [1 −1], and share the same comb offset and the same CS value. In addition, if one of the two symbols is dropped due to collision handling, the one SRS resource on the two symbols is dropped.

In some embodiment, the group of SRS resource(s) is two SRS resources each with four SRS ports, the four SRS ports of each SRS resource are associated with four antenna ports belonging to a different coherent antenna group. The SRS resource indicator field indicates an index corresponding to 2 SRI values, where each SRI value indicates one SRS resource, or the SRS resource indicator field indicates an SRI value that corresponds to 2 SRS resources.

In some embodiment, the group of SRS resource(s) is four SRS resources each with two SRS ports, the two SRS ports of each SRS resource are associated with two antenna ports belonging to a different coherent antenna group. The SRS resource indicator field indicates an index corresponding to 4 SRI values, where each SRI value indicates one SRS resource; or the SRS resource indicator field indicates an SRI value that corresponds to 4 SRS resources.

In the condition that the group of SRS resource(s) is two or four SRS resources each of which is received in a different symbol, if at least one of the symbols for receiving any of the SRS resources is dropped due to collision handling, the group of SRS resource(s) are dropped.

In some embodiment, the same frequency hopping parameters and/or the same repetition factors are configured for the SRS resources within an SRS group, and frequency hopping and/or frequency repetition are performed per SRS group of SRS resource(s).

In some embodiment, the group of SRS resource(s) is two SRS resource sets with a total of eight SRS resources each with one SRS port for non-codebook. If the two SRS resource sets are configured as aperiodic, the two aperiodic SRS resource sets are triggered by a same SRS request codepoint; and if the two SRS resource sets are configured as semi-persistent, the two semi-persistent SRS resource sets are activated or deactivated by a same MAC CE. The eight SRS resources within the two SRS resource sets may be associated with an aperiodic NZP CSI-RS resource, and a 42-symbols gap between the last symbol of the reception of the aperiodic NZP CSI-RS resource and the first symbol of the aperiodic SRS transmission in a first of the two SRS resource sets is satisfied.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a configuration of a group of SRS resource(s) associated with a same UL TCI state with a total of eight SRS ports for sounding eight antenna ports used for codebook or non-codebook based PUSCH transmission; and
receive a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

2. The UE of claim 1, wherein, the group of SRS resource(s) is one SRS resource with eight SRS ports.

3. The UE of claim 2, wherein, the eight SRS ports are transmitted in one symbol with different comb offsets and two or more different CS values.

4. The UE of claim 2, wherein, the eight SRS ports are transmitted in two adjacent symbols.

5. The UE of claim 4, wherein, if one of the two symbols is dropped due to collision handling, the one SRS resource on the two symbols is dropped.

6. The UE of claim 1, wherein, the group of SRS resource(s) is two SRS resources each with four SRS ports, the four SRS ports of each SRS resource are associated with four antenna ports belonging to a different coherent antenna group.

7. The UE of claim 6, wherein, the SRS resource indicator field indicates an index corresponding to 2 SRI values, where each SRI value indicates one SRS resource, or the SRS resource indicator field indicates an SRI value that corresponds to 2 SRS resources.

8. The UE of claim 1, wherein, the group of SRS resource(s) is four SRS resources each with two SRS ports, the two SRS ports of each SRS resource are associated with two antenna ports belonging to a different coherent antenna group.

9. The UE of claim 8, wherein, the SRS resource indicator field indicates an index corresponding to 4 SRI values, where each SRI value indicates one SRS resource; or the SRS resource indicator field indicates an SRI value that corresponds to 4 SRS resources.

10. The UE of claim 1, wherein, the same frequency hopping parameters and/or the same repetition factors are configured for the SRS resources within an SRS group, and frequency hopping and/or repetition are performed per SRS group of SRS resource(s).

11. The UE of claim 1, wherein, the group of SRS resource(s) is two SRS resource sets with a total of eight SRS resources each with one SRS port for non-codebook.

12. The UE of claim 11, wherein, if the two SRS resource sets are configured as aperiodic, the two aperiodic SRS resource sets are triggered by a same SRS request codepoint; and if the two SRS resource sets are configured as semi-persistent, the two semi-persistent SRS resource sets are activated or deactivated by a same MAC CE.

13. The UE of claim 11, wherein, the eight SRS resources within the two SRS resource sets are associated with an aperiodic NZP CSI-RS resource, and a 42-symbols gap between the last symbol of the reception of the aperiodic NZP CSI-RS resource and the first symbol of the aperiodic SRS transmission in a first of the two SRS resource sets is satisfied.

14. A method performed at a user equipment (UE), the method comprising:
receiving a configuration of a group of SRS resource(s) associated with a same UL TCI state with a total of eight SRS ports for sounding eight antenna ports used for codebook or non-codebook based PUSCH transmission; and
receiving a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

15. A base station unit, comprising:
at least one memory; and
at least one processor coupled with the at least one memory and configured to cause the base station to:
transmit a configuration of a group of SRS resource(s) associated with a same UL TCI state with a total of eight SRS ports for sounding eight antenna ports used for codebook or non-codebook based PUSCH transmission; and
transmit a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

16. A processor for wireless communication, comprising:
at least one controller coupled with at least one memory and configured to cause the processor to:
receive a configuration of a group of SRS resource(s) associated with a same UL TCI state with a total of eight SRS ports for sounding eight antenna ports used for codebook or non-codebook based PUSCH transmission; and
receive a DCI or a CG configuration for scheduling PUSCH transmission, wherein the DCI or the CG configuration contains an SRS resource indicator (SRI) field or an SRS resource set indicator (SRSI) field that indicates the group of SRS resource(s) for the scheduled PUSCH transmission.

17. The processor of claim 16, wherein, the group of SRS resource(s) is one SRS resource with eight SRS ports.

18. The processor of claim 17, wherein, the eight SRS ports are transmitted in one symbol with different comb offsets and two or more different CS values.

19. The processor of claim 17, wherein, the eight SRS ports are transmitted in two adjacent symbols.

20. The processor of claim 19, wherein, if one of the two symbols is dropped due to collision handling, the one SRS resource on the two symbols is dropped.
